(19) United States
(12) Patent Application Publication
(10) Pub. No.: US 2022/0238896 A1
(43) Pub. Date: Jul. 28, 2022

(54) COOLING SYSTEM FOR TWO-PHASE REFRIGERANT

(71) Applicant: Airbus Operations GmbH, Hamburg (DE)

(72) Inventor: Markus Piesker, Hamburg (DE)

(21) Appl. No.: 17/584,816

(22) Filed: Jan. 26, 2022

(30) Foreign Application Priority Data
Jan. 28, 2021 (DE) 10 2021 101 975.3

(51) Int. Cl. H01M 8/04007

(52) U.S. Cl. CPC H01M 8/04059; H01M 8/04074

(57) ABSTRACT

A cooling system containing a two-phase refrigerant, which cooling system includes a condenser, an evaporator and a conveying device. Liquid and gaseous refrigerant from the evaporator are collected in a collection vessel to which a first discharge line and a second discharge line are connected. Gaseous refrigerant is guided through the first discharge line to the condenser, whereas liquid refrigerant is conducted through the second discharge line to a part of the cooling system downstream of the condenser. Furthermore, a corresponding fuel cell cooling system is described which includes a fuel cell which forms the evaporator of the cooling system.

### CROSS-REFERENCES TO RELATED APPLICATIONS

This application claims the benefit of the German patent application No. 10 2021 101 975.3 filed on Jan. 28, 2021, the entire disclosures of which are incorporated herein by way of reference.

### FIELD OF THE INVENTION

The invention relates to a cooling system for a two-phase refrigerant and to an associated fuel cell cooling system. In particular, the invention relates to a cooling system for a two-phase refrigerant, having a collection vessel which collects liquid and gaseous refrigerant from the evaporator, and to a fuel cell cooling system, in which the evaporator of the cooling system is a fuel cell.

### BACKGROUND OF THE INVENTION

In the description which follows and the attached claims, a “two-phase refrigerant” refers to a medium (fluid) which changes its state of matter in the case of cold transfer or heat transfer. Generally, gaseous refrigerant is cooled in a condenser and thereby changes into the liquid state. As a result of heat exchange with an object or medium to be cooled, the liquid refrigerant can vaporize and can cool the object or medium to be cooled by withdrawing therefrom the energy required for vaporization of the refrigerant (enthalpy of vaporization).

The enthalpy of vaporization is dependent on the refrigerant used, wherein the refrigerant may be configured for the operating conditions of the cooling system in order to avoid an undesired phase change (change in state of aggregation) in sections of the cooling system other than the condenser and the evaporator. For this purpose, it is often the case that additional components are integrated into the cooling system, for example additional conveying devices for the gaseous refrigerant downstream of the evaporator, or a superheater for bringing all of the refrigerant downstream of the evaporator into the gaseous state. Furthermore, the operating conditions of the cooling system, for example a particular temperature range in the evaporator, can also entail additional control requirements and corresponding control components in the cooling system. All of these components however result in additional weight for the cooling system, which is disadvantageous in particular in the aircraft manufacturing sector.

### SUMMARY OF THE INVENTION

It is an object of the invention to provide a cooling system, and, in particular, a fuel cell cooling system, which has a simple construction and a low weight.

According to a first aspect for better understanding of the present disclosure, a cooling system containing a two-phase refrigerant comprises a condenser which is configured to cool the two-phase refrigerant and to convert gaseous refrigerant into liquid refrigerant and an evaporator which is configured to heat the two-phase refrigerant, wherein at least some of the refrigerant vaporizes to form gaseous refrigerant. The condenser can be thermally coupled to a heat sink; for example, what can flow through the condenser is a cold fluid (gas or liquid) which absorbs heat and cools the refrigerant in the condenser and, in doing so, converts gaseous refrigerant into the liquid state. The evaporator correspondingly serves as a cold source for a device to be cooled. The evaporator can absorb heat from the device to be cooled and can transfer the heat to the refrigerant, wherein, in the process, the refrigerant at least partially changes from the liquid state into the gaseous state.

The cooling system furthermore comprises a conveying device which is configured to convey the two-phase refrigerant from the condenser to the evaporator, and a control system, which is configured to control a delivery rate of the two-face refrigerant through the conveying device. By means of the conveying device and control system, the heat quantity that can be absorbed by the refrigerant in the evaporator can be controlled. For example, the quantity of the refrigerant that is fed to the evaporator, and a pressure of the refrigerant with which the refrigerant is fed to the evaporator, can be controlled. The evaporator and/or the device to be cooled can thus attain a substantially constant temperature.

The cooling system furthermore comprises a first collection vessel which is configured to collect the liquid and gaseous refrigerant from the evaporator. Connected to the first collection vessel are a first discharge line, which fluidically connects the first collection vessel to a part of the cooling system upstream of the condenser and which is configured to discharge gaseous refrigerant from the first collection vessel, and a second discharge line, which fluidically connects the first collection vessel to a part of the cooling system downstream of the condenser and which is configured to discharge liquid refrigerant from the first collection vessel.

The first collection vessel therefore serves for separation of gaseous and liquid refrigerant which leaves the evaporator. For example, the collection vessel may have two separate connections or openings to which the first and second discharge line are respectively connected. For example, a first connection for the first discharge line may be provided in a region of the collection vessel which is situated at the top in the installed state of the collection vessel or cooling system as a whole, whereas the second connection for the second discharge line is situated in a lower region of the installed collection vessel. In this way, liquid refrigerant can be separated from gaseous refrigerant owing to gravitational force.

As a result of the separation of the refrigerant, the condenser can operate more efficiently and can be dimensioned to be smaller, because exclusively gaseous refrigerant is fed thereto. Likewise, the liquid refrigerant is guided past the condenser and is fed to the cooling system again downstream of the condenser, that is to say in a region in which refrigerant is present in a liquid state of aggregation. Therefore, in the region between the evaporator and the condenser, the cooling system can comprise fewer components than is conventional (for example no additional conveying device), and can thus have less weight and be of lighter configuration. Furthermore, a diameter of the second discharge line can be kept small, because a continuous flow of liquid refrigerant is possible. Furthermore, only excess liquid refrigerant has to be recirculated from the outlet side of the condenser. Altogether, the weight of the cooling system can thus be considerably reduced.

According to a second aspect for improved understanding of the present disclosure, a fuel cell cooling system comprises a fuel cell and a cooling system according to the first aspect. In other words, the cooling system of the first aspect is used for cooling a fuel cell. In particular, the evaporator of the cooling system is the fuel cell or a section of the fuel cell by means of which, through cooling, the thermal operating conditions of the fuel cell can be maintained.

Normally, fuel cells are cooled by means of liquid heat transfer fluids, for example a water-based heat transfer fluid. The background to this is that as far as possible every section of the fuel cell stack must be evenly cooled. Sections of the fuel cell stack could otherwise be excessively heated in the case of poor or uneven cooling, whereby the fuel cell operates inefficiently or is even destroyed in the section in question. A liquid heat transfer fluid allows an even absorption of heat from all sections of the fuel cell.

In the present disclosure, however, a liquid heat transfer fluid is preferably dispensed with in order to reduce the weight of the cooling system. Therefore, a two-phase refrigerant is used, at least some of the refrigerant changing into the gaseous state in the evaporator, in this case the fuel cell. As a result, the cooling system is altogether lighter compared to a system containing solely liquid heat transfer fluid. For example, the cooling system has to be designed for solely liquid refrigerant only in the region between condenser outlet and evaporator inlet, whereas other sections of the cooling system are designed for gaseous refrigerant. Compared to conventional cooling circuits with purely liquid operation, the weight of the liquid refrigerant is not applicable in the region of gaseous refrigerant, and refrigerant lines can be smaller and thus lighter in the region of liquid refrigerant, since altogether less liquid refrigerant is required.

Alternatively, use may be made not of a fuel cell but of an electrolyzer that chemically splits a substance using supplied electrical energy in order to thus chemically store energy. For example, the electrolyzer can split water into hydrogen and oxygen by means of electrical current. It is self-evidently also possible for a cooling system (a cooling circuit) to comprise a fuel cell and an electrolyzer as evaporator. If the two electrical systems are for example operated temporally in succession, the same cooling system can be used for cooling both electrical systems.

It is likewise alternatively or additionally possible for the evaporator to be formed by a battery, an electronic component, an electric motor and/or a drive, which can likewise be cooled by the cooling system described.

According to a third aspect for improved understanding of the present disclosure, an aircraft comprises a fuel cell cooling system according to the second aspect. The aircraft can be a transport aircraft, passenger aircraft, light aircraft or a pseudo-satellite (high-altitude pseudo-satellite—HAPS). For example, the aircraft can be powered by electricity which is generated in the fuel cell, or certain electrical components in the aircraft can be powered by the electricity thus generated. Alternatively or additionally, the aircraft can also comprise an electrolyzer which is cooled by the cooling system. Any weight reduction is hugely important for an aircraft, since less energy is required for propulsion.

With regard to the second and third aspects, fuel cells and electrolyzers require relatively constant operating parameters, in particular an operating temperature that is as constant as possible. For example, the operating temperature can be between 70° C. and 90° C. or between 80° C. and 90° C. According to one configuration variant, in order to allow this relatively narrow temperature range in a lasting manner, the control system of the cooling system can furthermore be configured to capture operating conditions of the fuel cell and/or the electrolyzer, to ascertain a cooling demand of the fuel cell or of the electrolyzer on the basis of the operating conditions, and to operate the cooling system in such a way that the cooling demand of the fuel cell and/or the electrolyzer is covered.

For example, the control system may conduct as much refrigerant into the evaporator as is required in order to keep the fuel cell or the electrolyzer in the desired temperature range. For this purpose, the control system can ascertain a demand for electrical energy which is to be generated by the fuel cell or is available to the electrolyzer for chemical cleavage (for example on the basis of connected electrical loads or electricity generation devices, such as solar cells for example). The electrical energy is in relation to the quantity of heat generated by the fuel cell and/or the electrolyzer. It is this quantity of heat that is to be absorbed and taken away by the cooling system.

In a further exemplary configuration variant, the control system can feed such a quantity of refrigerant to the evaporator of the cooling system that the evaporator is operated in a wet vaporization process. In other words, more refrigerant is conducted into the evaporator than can be vaporized by the supply of heat from the fuel cell and/or the electrolyzer. The wet vaporization process causes liquid refrigerant to be present throughout the evaporator. This allows an even cooling effect along the flow direction of the refrigerant and thus an even heat distribution within the evaporator and within the fuel cell or the electrolyzer. Regions having strong heat development (so-called hotspots) can therefore be avoided.

Merely by way of example, at least 20% more refrigerant can be conducted into the evaporator than is vaporized therein. In other words, in the flow direction of the refrigerant downstream of the evaporator, 20% of the (formerly liquid) refrigerant is (continues to be) in liquid form, whereas the rest of the refrigerant has changed into the gaseous state in the evaporator.

Commonly, a fuel cell and an electrolyzer have channels, through which a heat transfer fluid is guided in order to cool them. According to the present aspects, the fuel cell or the electrolyzer form the evaporator. For example, the refrigerant of the cooling system can flow through the heat transfer fluid channels which are already present and which therefore form the evaporator. As a result, existing fuel cells and/or electrolyzers can be used with the cooling system described here.

Further configuration variants of the cooling system will be discussed below independently of the described aspects of the present disclosure.

For example, in one further configuration variant, the cooling system can comprise a first regulating valve which is arranged in the first discharge line and is configured to regulate a flow rate of the gaseous refrigerant through the first discharge line. The flow rate of the gaseous refrigerant through the first discharge line also determines the pressure that prevails in the first collection vessel and thus also in the evaporator. As a result of the expansion of the refrigerant in the evaporator as a result of the change into the gaseous state of aggregation and/or the heating of the refrigerant in the evaporator, the refrigerant has a higher pressure when it leaves the evaporator than when it enters the evaporator. By shutting off the first regulating valve, the quantity of gaseous refrigerant that can flow away downstream of the evaporator can be determined, and thus the pressure prevailing there can also be regulated.

For example, the control system may furthermore be configured to control the first regulating valve such that the refrigerant in the first collection vessel has a higher pressure than the refrigerant in the part of the cooling system downstream of the condenser (outlet side of the condenser). The pressure in the part of the cooling system downstream of the condenser is significantly determined by the cooling and condensation of the refrigerant in the condenser. Conversely to the increasing pressure in the evaporator, the pressure is lower at the outlet side of the condenser than at the inlet side thereof.

The pressure difference between the first collection vessel and outlet side of the condenser can be used to move the liquid refrigerant through the second discharge line from the first collection vessel to the part of the cooling system downstream of the condenser. In other words, the pressure of the refrigerant in the first collection vessel is used to force the liquid refrigerant out of the first collection vessel. For this purpose, the gaseous refrigerant must have sufficient energy to convey the liquid refrigerant to the outlet side of the condenser, and optionally to also flow independently to the inlet side of the condenser.

In this way, no separate conveying device is required for the gaseous and liquid refrigerant from the evaporator to the condenser or the part of the cooling system downstream of the condenser, such as is often used in conventional cooling systems. Furthermore, the liquid refrigerant can also be moved counter to the force of gravity from the first collection vessel to the outlet side of the condenser, such that the cooling system can be of simpler construction and/or can be adapted to the special boundary conditions without the need for a natural gradient to be provided in the second discharge line. The liquid refrigerant can thus be conveyed exclusively by means of the control system and the first regulating valve.

Alternatively or in addition, in a further configuration variant, at least a section of the first discharge line can have a fixed flow resistance which is predetermined such that the refrigerant in the first collection vessel has a higher pressure than the refrigerant in the part of the cooling system downstream of the condenser. In other words, instead of or in addition to the first regulating valve, the flow rate of the gaseous refrigerant from the first collection vessel to the condenser is restricted by the first discharge line itself, so that pressure builds up in the first collection vessel. Owing to the pressure difference now present between the first collection vessel and the outlet side of the condenser, the liquid refrigerant can be conveyed from the first collection vessel to the outlet side of the condenser without additional devices and/or without the aid of gravity.

For example, the first discharge line can have a section which has a smaller diameter than other lines of the cooling system, certain flow-impeding fittings and/or a short narrowing of the flow cross section in the flow direction. This can save weight, especially since a first regulating valve is not necessary. Moreover, control complexity can be reduced. The pressure difference between first collection vessel and outlet side of the condenser can, in this case, be exclusively controlled via the conveying device and the conveyed quantity of refrigerant in the evaporator. Especially in cooling systems having even heat generation by the device to be cooled using the evaporator, constant operation of the cooling system is possible even without a first regulating valve.

Furthermore, by means of the first regulating valve or the particular section of the first discharge line, not only the pressure but also the temperature of the refrigerant can be regulated or determined. In this way, the temperature of the refrigerant can be optimized for the condensation in the condenser but also for the vaporization in the evaporator. For example, the temperature and the pressure of the refrigerant downstream of the evaporator can be controlled in a manner dependent on a temperature of the heat sink for the condenser (for example, cold air flow). Here, an optimum temperature and an optimum pressure of the refrigerant in the evaporator can be realized. Furthermore, an optimum temperature and an optimum pressure of the refrigerant in the condenser can also be realized.

Optionally, by means of the first regulating valve, the pressure in the first discharge line can be reduced, which causes superheating of the gaseous refrigerant in the first discharge line. Here, superheating means that the gaseous refrigerant does not condense as it flows through the first discharge line before reaching the condenser.

Alternatively or additionally, the refrigerant in the first discharge line can also be heated by supplying heat energy. Any available heat source can be used for this purpose. For example, the refrigerant can be heated between 5 K and 15 K, preferably by 10 K, above the boiling temperature (the dew point) in order to achieve sufficient superheating of the refrigerant.

Furthermore, the first regulating valve may be an electric valve that can regulate the flow through the first discharge line in continuously variable fashion, for example by means of the control system.

In another configuration variant, the cooling system can furthermore comprise a second collection vessel which is configured to collect the liquid refrigerant from the condenser. In other words, the second collection vessel is fluidically connected to the condenser downstream thereof, so that condensed (now liquid) refrigerant in the condenser flows into the second collection vessel. The second collection vessel serves as a reservoir of liquid refrigerant for the conveying device, so that gaseous refrigerant does not reach the conveying device and, as a result, damage to the conveying device can be avoided.

For example, the second discharge line can fluidically connect the first collection vessel to the second collection vessel. The central task of the second collection vessel is to form a reservoir of liquid refrigerant for the section of the cooling system leading up to the evaporator. Therefore, liquid refrigerant which is separated from the gaseous refrigerant in the first collection vessel can be directly conducted into the second collection vessel. The second discharge line thus forms a bypass of the condenser.

In a further configuration variant, the cooling system may furthermore comprise a supply line which fluidically couples the conveying device to the evaporator. Liquid refrigerant is supplied to the evaporator through the supply line.

Here, the supply line can, for example, have a fixed flow resistance which determines the flow rate of liquid refrigerant through the supply line into the evaporator. It is likewise also possible for flow-impeding fittings in the supply line and/or a narrowing of the flow cross section to be provided in order to define the fixed flow resistance in the supply line.

Alternatively or in addition, the cooling system can comprise a second regulating valve which is arranged in the supply line and is configured to regulate a flow rate of the liquid refrigerant through the supply line. The second regulating valve can for example close, and fully open (in continuously variable fashion), the passage cross section of the supply line. In this way, a finer determination of the refrigerant quantity in the evaporator is possible, but entails the additional weight for the second regulating valve. The heat quantity that can be absorbed in the evaporator and taken away can thus be more rapidly and more precisely adjusted, for example adapted to the present demand.

Furthermore, the controller may optionally be configured to control the second regulating valve such that the evaporator is filled with the optimum refrigerant quantity. The optimum refrigerant quantity is determined on the basis of the operating parameters of the device to be cooled (for example fuel cell or electrolyzer) and thus the heat quantity to be discharged.

Furthermore, the control system can control the second regulating valve in such a way that the evaporator is operated in a wet vaporization process. In other words, through the second regulating valve, more liquid refrigerant is conducted into the evaporator than vaporizes in the evaporator, such that liquid refrigerant also leaves the evaporator again.

In a particular configuration variant, the second regulating valve can be connected to a further refrigerant line which fluidically connects the second regulating valve to the second collection vessel. For example, the second regulating valve can be implemented in such a way that between 0% and 100% of refrigerant is conducted from the conveying device into the evaporator via the supply line, whereas the correspondingly remaining or entire quantity of refrigerant (between 100% and 0%) is conducted from the conveying device into the collection vessel. As a result, the quantity of refrigerant which is supplied to the evaporator can be determined independently of the rate of change of the delivery rate of the conveying device. Moreover, the conveying device can also be operated in a more constant manner, and it is treated with care as a result. Altogether, this can reduce the total quantity of liquid refrigerant in the cooling system and optimize and reduce the size of the first and/or second collection vessel. This can further save weight.

In a further configuration variant, the cooling system can furthermore comprise a preheating heat exchanger that heats the refrigerant in the supply line to the evaporator. This is advantageous, in particular, if the evaporator or the device to be cooled by the evaporator reacts sensitively to temperature changes. In other words, it should be sought for refrigerant with as constant a temperature as possible to be conducted into the evaporator. Owing to external circumstances, however, the refrigerant may be cooled to different degrees in the refrigeration system before arriving at the evaporator. For example, fuel cells and electrolyzers are sensitive to temperature changes and have an efficiency dependent on their temperature. On the other hand, pseudo-satellites, in particular, are subject to intense temperature fluctuations. This way, at night, cooling of the refrigerant can occur not only in the condenser but also in the lines of the cooling system.

Furthermore, the preheating heat exchanger can, for example, thermally couple the refrigerant in the supply line to the refrigerant downstream of the evaporator.

For example, the preheating heat exchanger may be arranged in the evaporator, preferably at an outlet of the evaporator, which is situated downstream as viewed in the flow direction of the refrigerant. In this way, heat generated in the evaporator (or the device to be cooled) can be used directly to heat the liquid refrigerant in the supply line. By means of this direct thermal coupling, it is possible to realize a substantially constant temperature of the (liquid) refrigerant in and at the evaporator.

Alternatively or in addition, the preheating heat exchanger may be arranged in the first collection vessel. In this way, thermal coupling between refrigerant in the supply line and refrigerant in the first collection vessel is made possible. Since the refrigerant in the first collection vessel originates from the evaporator and has therefore been heated, it can be used effectively for heating the refrigerant in the supply line. Furthermore, the temperatures of the refrigerant upstream and downstream of the evaporator can be approximated or aligned, such that the refrigerant in the evaporator continuously has a constant temperature. The cooling effect in the evaporator can thus be achieved virtually exclusively on the basis of the enthalpy of vaporization of the refrigerant in the evaporator. Furthermore, by means of this arrangement of the preheating heat exchanger, the gaseous refrigerant in the first collection vessel can (at the preheating heat exchanger arranged therein) condense upon the thermal coupling to the liquid refrigerant in the supply line, and can be collected.

Likewise alternatively or in addition, the preheating heat exchanger (or a further preheating heat exchanger connected in series) can thermally couple the refrigerant in the feed line to the gaseous refrigerant in the first discharge line. For example, the preheating heat exchanger may be arranged in a section of the first discharge line that is situated upstream of the condenser. In this way, the condenser can be dimensioned to be smaller, because the gaseous refrigerant in the first discharge line already releases heat to the liquid refrigerant in the supply line. Furthermore, the pressure difference between the evaporator and condenser can be increased in order to improve the return flow of the refrigerant from the first collection vessel to the condenser or the outlet side of the condenser.

Further alternatively or in addition, the preheating heat exchanger (or a further preheating heat exchanger connected in series) may be arranged in the second collection vessel.

It is likewise alternatively or additionally possible for the refrigerant in the supply line to be heated by means of a heating device (electric heater) or some other heat-releasing component.

In yet a further configuration variant, the cooling system can furthermore comprise a supercooler which is configured to supercool refrigerant downstream of the condenser and upstream of the conveying device. Supercooling of the refrigerant prevents cavitation in the conveying device, since the refrigerant has been cooled further below its boiling point. For example, the supercooler can reduce the temperature of the refrigerant leaving the condenser by 2 to 10 K, preferably by 5 K, (below the outlet temperature at the condenser or below the boiling point).

Furthermore, the supercooler can be integrated in the condenser, form part of the condenser or be a section of the condenser. As a result, the condenser and the supercooler can share a heat sink (for example a cold fluid, cold air stream, etc.). Alternatively, the supercooler can also be implemented separately from the condenser and have its own heat sink.

In another configuration variant, the first collection vessel may be part of the evaporator, be a section of the evaporator or be integrated therein. Furthermore, the first collection vessel may also be implemented in the form of a line that is connected to the outlet side of the evaporator. For example, the line may have a widened portion that functions as first collection vessel.

In a further configuration variant, the cooling system can comprise at least one pressure sensor and/or temperature sensor which measures the pressure and/or the temperature of the refrigerant at a relevant position in the cooling system. The control system can access the signals or data of the at least one sensor in order to control the conveying device, the first regulating valve and/or the second regulating valve.

Merely by way of example, the at least one sensor can be arranged in the first collection vessel and/or in the second collection vessel. As a result, the pressure and/or the temperature downstream of the evaporator and/or downstream of the condenser can be determined. Furthermore, fuel cells or electrolyzers are already equipped with such sensors, which can be coupled to the control system in order to determine the pressure and/or the temperature of the refrigerant in the evaporator.

In the case of a known volume of the first and/or second collection vessel (or of the entire cooling system), the control system can determine the volume of the liquid and/or gaseous refrigerant on the basis of the sensor signals or data and taking into account the laws of thermodynamics Especially in the case of constant operation of the cooling system and thus a substantially homogeneous temperature distribution of the refrigerant within the cooling system, the entire (liquid) quantity of refrigerant can be calculated. As a result, the control system can also be configured to detect a leak or a loss of refrigerant.

Alternatively or additionally, fill-level sensors can also be provided in the first and/or the second collection vessel in order to determine the quantity of liquid refrigerant.

Furthermore, the control system can control the cooling system (or its components) in such a way that the pressure in the cooling system downstream of the evaporator is about 3.2 bar and that downstream of the condenser is 2.4 bar. The pressure difference between 3.2 and 2.4 bar is normally sufficient for conveying the liquid refrigerant from the first collection vessel to the section of the cooling system downstream of the condenser. Furthermore, the pressure difference, which is also present between the first collection vessel and a section of the cooling system upstream of the condenser, is sufficient for converting the refrigerant after exit from the evaporator, where it is a saturated vapor, into superheated vapor.

In one configuration variant, the refrigerant can be R1336mzz(Z), R134a, methanol or CO2 (carbon dioxide). It is self-evident that any other two-phase refrigerant can be used. However, R1336mzz(Z) is especially suitable in a cooling system having a fuel cell or electrolyzer as the evaporator, the fuel cell or electrolyzer being optimally operated at a temperature of approximately 85° C., since R1336mzz(Z) vaporizes at a pressure between 2.4 and 3.2 bar and a temperature between 70° C. and 90° C. This can achieve optimal cooling of the fuel cell or the electrolyzer at optimal operating temperature. In addition, R1336mzz(Z) is electrically nonconductive, meaning that it can be introduced into the fuel cell or the electrolyzer.

In a further configuration variant, the condenser can be operated in such a way (be cooled by the heat sink in such a way) that the pressure difference in relation to the pressure of the refrigerant in the first collection vessel is sufficient for conveying the gaseous and the liquid refrigerant to the condenser and/or to the section of the cooling system downstream of the condenser. Thus, a flow rate of the cooling medium of the heat sink can be controlled in such a way that a desired condenser temperature and thus temperature profile of the refrigerant from the inlet to the outlet of the condenser is achieved.

Furthermore, the control system can control the cooling system (or its components) such that the temperature of the liquid refrigerant is substantially even throughout the entire cooling system. It is only as a result of the vaporization of the refrigerant in the evaporator that the pressure of the refrigerant changes downstream of the evaporator (in particular in the first collection vessel) and changes again in the condenser. As a result of the homogeneous temperature distribution, temperature fluctuations in the evaporator (or the device to be cooled) are avoided, whereby the evaporator or device can be operated in a more conserving manner.

In yet a further configuration variant, the cooling system can comprise a third regulating valve which is arranged in the second discharge line and is configured to regulate a flow rate of the liquid refrigerant through the second discharge line. The third regulating valve allows not only the regulation of the flow rate (for example by the control system), but also regulation of the pressure in the first collection vessel. Especially in the starting phase of the cooling system, a higher pressure in the evaporator and in the cooling system on the outlet side of the evaporator can be built up as a result.

In another configuration variant, the first discharge line or at least a section thereof can be designed as a double-wall pipe. In this connection, an inner pipe of the first discharge line can guide liquid refrigerant, for example refrigerant from the conveying device. For example, the inner pipe of the first discharge line can form the supply line from the conveying device to the evaporator. In the outer pipe of the first discharge line, gaseous refrigerant can be guided from the evaporator or the first collection vessel to the condenser, that is to say can form the first discharge line. As a result, the gaseous refrigerant in the first discharge line is heated by the liquid refrigerant, thereby preventing condensation in the first discharge line.

It is self-evident that the above-described aspects, configurations, variants and examples can be combined without this having been explicitly described. Each of the described configuration variants and each example are thus to be regarded as optional with regard to each of the aspects, designs, variants and examples or even combinations thereof. The present disclosure is consequently not limited to the individual configurations and configuration variants in the sequence described, or to a particular combination of the aspects and configuration variants.

### BRIEF DESCRIPTION OF THE DRAWINGS

Preferred exemplary embodiments of the invention will now be explained in more detail with reference to the appended schematic drawings, in which:

FIG. 1 schematically shows a first variant of a cooling system;

FIG. 2 schematically shows a second variant of a cooling system;

FIG. 3 schematically shows a third variant of a cooling system; and

FIG. 4 schematically shows a fourth variant of a cooling system.

### DETAILED DESCRIPTION OF THE PREFERRED EMBODIMENTS

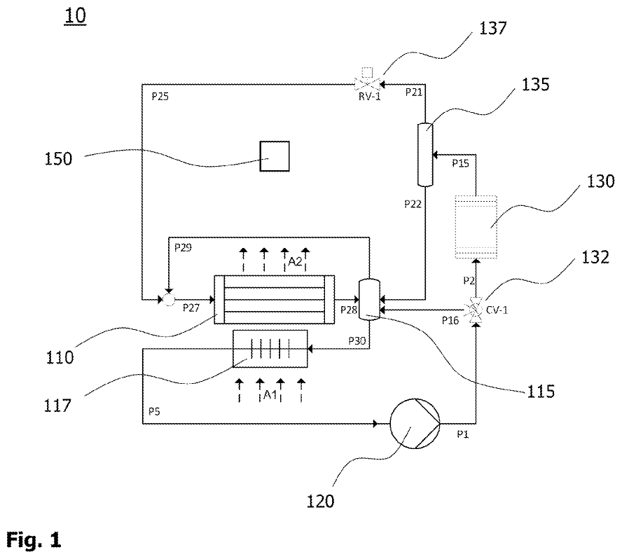

FIG. 1 schematically shows a first variant of a cooling system 10 which comprises a condenser 110, an evaporator 130 and a conveying device 120. The evaporator 130 is, for example, connected to the conveying device 120 via a supply line P1, P2, so that a refrigerant of the cooling system 10 can be conducted from the conveying device 120 into the evaporator 130. In the evaporator 130, the refrigerant, which is a two-phase refrigerant, can absorb heat energy and, as a result, at least some of the refrigerant vaporizes. In the further course of the cooling system 10, which will be described in more detail, the refrigerant flows to the condenser 110, in which it is cooled and condensed and is subsequently resupplied to the conveying device 120 in a liquid state. For this purpose, the condenser 110 can be thermally coupled to a heat sink A2, for example in the form of a cold fluid stream (outside air in the case of a vehicle).

Downstream of the evaporator 130 (or integrated therein or connected thereto) is a first collection vessel 135 which is configured for collection and separation of the liquid and gaseous refrigerant from the evaporator 130. For example, the first collection vessel 135 can be fluidically connected to an outlet of the evaporator 130 via a line P15.

The cooling system 10 has a first discharge line P21 which fluidically connects the first collection vessel 135 to a part of the cooling system 10 upstream of the condenser 110. As a result, gaseous refrigerant can be discharged from the first collection vessel 135 and be conducted into the condenser 110 for condensation. In the first discharge line P21, there can be arranged a first regulating valve 137 which is configured to regulate a flow rate of the gaseous refrigerant through the first discharge line P21. In this connection, the first discharge line is formed by the line sections P21 and P25. A pressure in the first collection vessel 135 can be controlled by means of the first regulating valve 137.

Alternatively, a section of the first discharge line, for example the line section P21 directly after the first collection vessel 135, can have a fixed flow resistance. In this connection, the fixed flow resistance can be adapted to the entire system in order to build up a higher pressure in the first collection vessel 135 than in the part of the cooling system 10 downstream of the condenser 110. As a result, the first regulating valve 137 can be dispensed with.

Furthermore, the cooling system 10 has a second discharge line P22 which fluidically connects the first collection vessel 135 to a part of the cooling system 10 downstream of the condenser 110. By means of the second discharge line P22, liquid refrigerant can be discharged from the first collection vessel 135 and be resupplied to the cooling system in a region which guides liquid refrigerant, that is to say, downstream of the condenser 110. From there, it can be resupplied to the conveying device 120, for example via the lines P30 and P5. The liquid refrigerant in the second discharge line P22 can be brought about solely on the basis of a pressure difference between the first collection vessel 135 and the section of the cooling system 10 downstream of the condenser 110. An additional conveying device is not necessary. Optionally, a regulating valve (not shown) can be integrated in the second discharge line P22 in order, for example, to build up the pressure difference (the higher pressure in the first collection vessel 135) and/or a fill level of liquid refrigerant in the evaporator 130 more rapidly.

FIG. 1 furthermore shows a second collection vessel 115 which is configured to collect the liquid refrigerant from the condenser 110. In this connection, the second discharge line P22 can fluidically connect the first collection vessel 135 to the second collection vessel 115. The second collection vessel 135 may also be integrated into the condenser 110 or may be a (widened) section of a refrigerant line P28, P30 downstream of the condenser 110.

If gaseous refrigerant accumulates in the second collection vessel 135, the second collection vessel 135 can be fluidically connected via a return line P29 to an inlet side of the condenser 110. For example, the return line P29 can open into a line section P27 of the cooling system upstream of the condenser 110. In order to avoid a bypass of the condenser 110, a check valve can be provided at the end of the return line P29.

In order to prevent gaseous refrigerant from getting into the conveying device 120, a supercooler 117 can be provided in a section of the cooling system between condenser 110 and conveying device 120, for example between second collection vessel 115 and conveying device 120. The supercooler 117 can have its own heat sink A1 (air stream or other cold fluid) and not that of the condenser 110. Alternatively, the supercooler 117 and the condenser 110 can share a heat sink (not depicted) and/or the supercooler 117 and the condenser 110 form a unit (not shown), that is to say, are mutually integrated.

Finally, FIG. 1 additionally depicts a second regulating valve 132 which is arranged in the supply line P1, P2 and is configured to regulate a flow rate of the refrigerant through the supply line P2. In particular, the second regulating valve 132 can determine the quantity of refrigerant that is supplied to the evaporator 130. As a result, the cooling performance of the evaporator 130 is controlled, and thus also the pressure in the evaporator 130 and in the sections of the cooling system 10 downstream of the evaporator 130.

Optionally, the second regulating valve 132 can also be a branch of the supply line P2 and conduct at least some of the refrigerant conveyed through the line P1 by the conveying device 120 back into a section of the cooling system 10 downstream of the condenser 110 via a line section P16. For example, the line section P16 can open into the second collection vessel 115. As a result, the conveying device 120 can be operated continuously, whereas the inflow into the evaporator 130 is controlled via the second regulating valve 132.

The cooling system 10 has furthermore a control system 150 (or control unit, processor or computer) which is configured to control the conveying device 120 and especially its delivery rate of liquid refrigerant through the lines P5 and P1. Furthermore, the control system 150 can also determine and control the opening and closing and also a degree of opening of the regulating valves 132, 137. In addition, the control system 150 is configured to regulate the operation of the condenser 110 and/or the supercooler 117, for example by control of the supply of cold fluid as heat sink A1, A2.

Furthermore, the cooling system 10 can have sensors, especially pressure sensors and temperature sensors (not depicted). By means of the sensors, the control system 150 can ascertain the pressure and/or the temperature of the refrigerant at the relevant section of the cooling system 10 and control the conveying device 120 and/or regulating valves 132, 137 and/or heat sinks A1, A2. In this connection, the control system 150 is especially designed to ensure a temperature in the evaporator 130 that is as constant as possible. In particular if the evaporator 130 forms a fuel cell or an electrolyzer (or a part thereof), a constant temperature in the fuel cell/electrolyzer is optimal for the operation thereof. Moreover, the pressure difference between first collection vessel 135 and second collection vessel 115 can be built up and held by means of the control system 150 and, as a result, efficient operation of the cooling system 10 is made possible in a rapid and lasting manner.

Merely by way of example, the control system 150 can carry out various procedures in order to start the cooling system 10. For example, the second regulating valve 132 can be controlled in such a way that only a connection between line P1 and bypass P16 is present, whereas the first regulating valve 137 is open. Now, the heat sink A1 of the condenser 110 is put into operation in order to allow a temperature and pressure of the refrigerant for operation of the evaporator 130 (of the fuel cell or of the electrolyzer). If sufficient liquid refrigerant is present in the section downstream of the condenser 110, for example in the second collection vessel 115, the control system 150 starts the conveying device 120.

The control system 150 can be configured to determine the cooling demand of the evaporator 130. For example, the control system 150 can be supplied with signals or data which reflect an operating state of the device to be cooled. For example, on the basis of the consumed or generated electricity of a fuel cell or an electrolyzer, it is possible to ascertain how high the cooling demand of the fuel cell or the electrolyzer is. Accordingly, the control system can control the second regulating valve 132 in such a way that the necessary quantity of liquid refrigerant gets into the evaporator 130 through the line P2. As a result of the pressure now rising in the first collection vessel 135, the control system 150 can (at least partially) close the first regulating valve 137 in order to establish the above-described pressure difference between first and second collection vessel 135, 115.

Here, the control system 150 can limit the pressure in the first collection vessel 135 and thus in the evaporator 130 to a maximum. For example, the pressure in a fuel cell or an electrolyzer should be limited to a certain value, for example 3.5 bar, in order to ensure the reliable operation thereof. By means of the first regulating valve 137, the pressure in the evaporator 130, but also the quantity of liquid refrigerant in the evaporator 130, is controllable. Therefore, optimal operation of the fuel cell or the electrolyzer can be ensured.

The control system 150 can furthermore be configured to calculate (by means of pressure and temperature sensors) or measure (by means of a fill-level sensor) a fill level of liquid refrigerant in the evaporator 130. If a sufficient fill level has been reached, the control system 150 can close the second regulating valve 132 and/or reduce the delivery rate of the conveying device 120. In particular, the control system 150 can now operate the evaporator 130 in a wet vaporization process.

Furthermore, the control system 150 is configured to regulate the operation of the condenser 110 and/or the supercooler 117 in order to provide sufficient liquid refrigerant on the inlet side (upstream) of the conveying device 120. In particular, the heat sink A1 or A2 can be regulated here by the control system 150 in order to condense (liquefy) more or less refrigerant, and to hold it available in the second collection vessel 115, for example.

Lastly, the control system 150 can prevent the line P25 of the cooling system 10, which line guides gaseous refrigerant, from being flooded with liquid refrigerant. For this purpose, the quantity of liquid refrigerant in the supply line P2 can be controlled by closure of the second regulating valve 132 and can, for example, be diverted into the bypass P16.

In a further exemplary case, the control system 150 can also be designed to control the device to be cooled (for example the fuel cell or the electrolyzer). This is, for example, necessary if the cooling system 10 cannot achieve sufficient cooling performance in the evaporator 130. In the event of a leakage of the refrigerant from the cooling system 10 or an excessively high temperature of the heat sink A1, A2, it may be necessary to reduce the output of the device to be cooled and the associated heat quantity generated. In particular, the control system 150 is configured to capture the operating parameters of the device to be cooled and of the cooling system 10 and to ascertain in advance whether sufficient cooling of the device to be cooled can be achieved or whether the output (heat generation) of the device to be cooled must be reduced. Here, the control system 150 can take into account the maximum permissible pressure in the evaporator 130 and also minimum fill levels in the first and/or second collection vessel 135, 115 and in the evaporator 130.

It is self-evident that the control system 150 can also switch off the device to be cooled and the entire cooling system 10 in order to avoid damage to the device to be cooled and/or the cooling system 10. Here, the control system 150 can be configured to open the first regulating valve 137 in order to supply as much gaseous refrigerant as possible to the condenser 110. As a result, sufficient liquid refrigerant can be held available, for example in the second collection vessel 115, for later renewed starting of the cooling system.

If the refrigerant downstream of the conveying device 120 is too cold to be conducted into the evaporator 130 (for example, the operation of a fuel cell or an electrolyzer may be hindered or stopped in the event of excessively strong cooling), the refrigerant in the line section P1 or P2 can be heated. In the simplest case, a separate heater (not depicted) can be provided in order to provide the optimal temperature of the refrigerant for the evaporator 130.

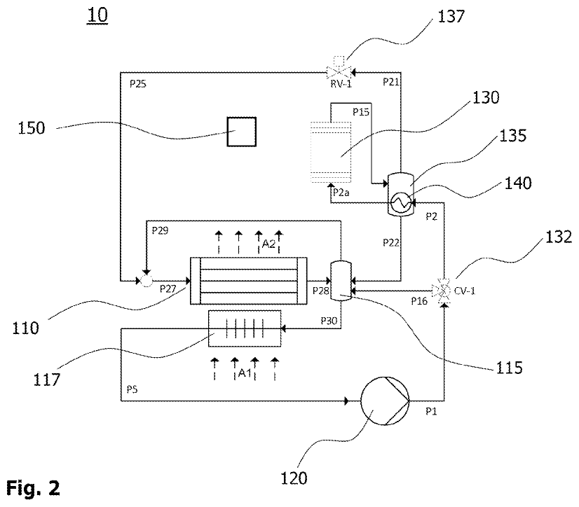

Another form of heating of the refrigerant downstream of the conveying device 120 is depicted in FIG. 2. The cooling system 10 shown comprises a multiplicity of components which are also comprised in the cooling system 10 according to FIG. 1, and so the description thereof is not repeated here.

In the cooling system 10 as per FIG. 2, a preheating heat exchanger 140 is integrated in the supply line P2 and thermally couples the liquid refrigerant in the supply line P2, P2a to the refrigerant at the outlet side of the evaporator 130. For example, as illustrated in FIG. 2, the heat exchanger 140 can be arranged in the first collection vessel 135, such that the refrigerant in the first collection vessel 135 flows around the heat exchanger and the refrigerant in the supply line P2, P2a flows through the heat exchanger, and the heat exchanger provides thermal coupling between the two. In this way, the temperature of the refrigerant that is guided in the evaporator 130 can be kept as constant as possible over the time of operation of the cooling system 10.

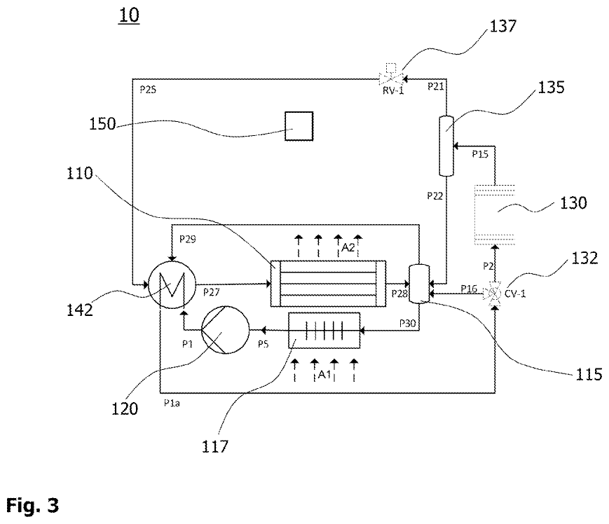

A further alternative or additional possibility for heating the liquid refrigerant is shown in FIG. 3. The cooling system 10 shown comprises a multiplicity of components which are also comprised in the cooling system 10 according to FIG. 1, and so the description thereof is not repeated here. Here, a preheating heat exchanger 142 is integrated into the supply line section P1 between the conveying device 120 and second regulating valve 132. In the preheating heat exchanger 142, the liquid refrigerant, after leaving the conveying device 120, is thermally coupled to the gaseous refrigerant in the first discharge line P21, P25. The resulting cooling of the gaseous refrigerant reduces the cooling demand in the condenser 110.

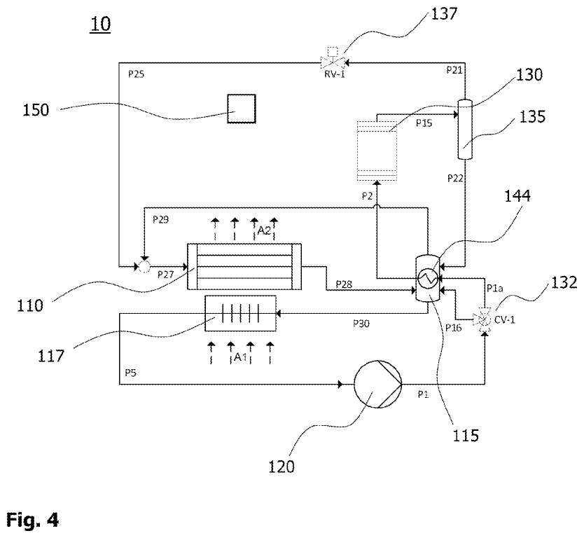

FIG. 4, finally, shows a further alternative or additional possibility for heating the liquid refrigerant. The cooling system 10 shown comprises a multiplicity of components which are also comprised in the cooling system 10 according to FIG. 1, and so the description thereof is not repeated here. Here, a preheating heat exchanger 144 is integrated in the supply line P2, the preheating heat exchanger being arranged in the second collection vessel 115. In this way, the heat exchanger 144 can realize thermal coupling between the liquid refrigerant in the supply line P2 of the evaporator 130 and the liquid refrigerant in the second collection vessel 115.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cooling system containing a two-phase refrigerant, comprising:
a condenser configured to cool the two-phase refrigerant and to convert gaseous refrigerant into liquid refrigerant;
an evaporator configured to heat the two-phase refrigerant, wherein at least some of the refrigerant vaporizes to form gaseous refrigerant;
a conveying device configured to convey the two-phase refrigerant from the condenser to the evaporator;
a control system configured to control a delivery rate of the two-phase refrigerant through the conveying device;
a first collection vessel configured to collect the liquid refrigerant and gaseous refrigerant from the evaporator;
a first discharge line fluidically connecting the first collection vessel to a part of the cooling system upstream of the condenser and being configured to discharge gaseous refrigerant from the first collection vessel; and
a second discharge line fluidically connecting the first collection vessel to a part of the cooling system downstream of the condenser and being configured to discharge the liquid refrigerant from the first collection vessel.

2. The cooling system according to claim 1, further comprising:
a first regulating valve arranged in the first discharge line and being configured to regulate a flow rate of the gaseous refrigerant through the first discharge line;
wherein the control system is furthermore configured to control the first regulating valve such that the refrigerant in the first collection vessel has a higher pressure than the refrigerant in the part of the cooling system downstream of the condenser.

3. The cooling system according to claim 1, wherein at least a section of the first discharge line has a fixed flow resistance which is predetermined such that the refrigerant in the first collection vessel has a higher pressure than the refrigerant in the part of the cooling system downstream of the condenser.

4. The cooling system according to claim 1, further comprising:
a second collection vessel configured to collect the liquid refrigerant from the condenser;
wherein the second discharge line fluidically connects the first collection vessel to the second collection vessel.

5. The cooling system according to claim 1, further comprising:
a supply line fluidically connecting the conveying device to the evaporator; and
a second regulating valve arranged in the supply line and being configured to regulate a flow rate of the refrigerant through the supply line,
wherein the control system is furthermore configured to control the second regulating valve such that the evaporator is operated in a wet vaporization process.

6. The cooling system according to claim 5, further comprising:
a preheating heat exchanger thermally coupling the refrigerant in the supply line to the refrigerant downstream of the evaporator.

7. The cooling system according to claim 6, wherein at least one of
the preheating heat exchanger is arranged in the first collection vessel, or
the preheating heat exchanger thermally couples the refrigerant in the supply line to the gaseous refrigerant in the first discharge line, upstream of the condenser.

8. The cooling system according to claim 6,
further comprising a second collection vessel configured to collect the liquid refrigerant from the condenser;
wherein the second discharge line fluidically connects the first collection vessel to the second collection vessel, and
wherein the preheating heat exchanger is arranged in the second collection vessel.

9. The cooling system according to claim 1, further comprising:
a supercooler configured to supercool refrigerant downstream of the condenser and upstream of the conveying device.

10. A fuel cell cooling system, comprising:
a fuel cell; and
a cooling system according to claim 1,
wherein the evaporator of the cooling system is the fuel cell.

11. The fuel cell cooling system according to claim 10, wherein the control system of the cooling system is furthermore configured to capture operating conditions of the fuel cell, to ascertain a cooling demand of the fuel cell based on the operating conditions, and to operate the cooling system such that the cooling demand of the fuel cell is covered and the evaporator of the cooling system is operated in a wet vaporization process.
